(19) United States
(12) Patent Application Publication
(10) Pub. No.: US 2022/0377487 A1
(43) Pub. Date: Nov. 24, 2022

(54) DIRECTIONAL SOUND TRANSMISSION METHOD, ELECTRONIC DEVICE AND READABLE STORAGE MEDIUM

(71) Applicant: Nanning FuLian FuGui Precision Industrial Co., Ltd., Nanning (CN)

(72) Inventor: YU-QIANG ZHONG, Nanning (CN)

(21) Appl. No.: 17/351,467

(22) Filed: Jun. 18, 2021

(30) Foreign Application Priority Data
May 18, 2021 (CN) 202110540275.4

(51) Int. Cl. H04S 7/00; H04R 5/02; H04S 3/00; G06K 9/00

(52) U.S. Cl. CPC H04S 7/303; H04R 5/02; H04S 3/008; G06K 9/00228; G06K 9/00335

(57) ABSTRACT

A directional sound transmission method executable by an electronic device is disclosed. A camera of the electronic device is activated. A divided area within a detectable range of the camera is recognized. A first detection operation is performed on first character information of a first person in the detectable range. A first three-dimensional (3D) coordinate information of a face of the first person is recognized through the camera, and the first 3D coordinate information is obtained. A first ultrasonic transducer transmitter corresponding to the first person is activated and the sound of the electronic device is sent to the first person.

### BACKGROUND

### 1. Technical Field

The disclosure relates to Internet communications, and more particularly to a directional sound transmission method.

### 2. Description of Related Art

As an advanced form of ultra-high-definition video, 8K brings an all-round improvement in picture and sound quality. In terms of the picture quality, according to the BT.2020 recommendations formulated by the International Telecommunication Union (ITU) for the 4K/8K technologies, the resolution of each frame of 8K video, i.e. Ultra High Definition Television 2 (UHDTV2) is 4 times that of 4K video, i.e. UHDTV1, and the color depth of 8K video is up to 12 bit, which is consistent with the color depth standard of Dolby Vision and is better than the current mainstream High Dynamic Range 10 (HDR10), thus presenting a clear picture closer to nature. In terms of the sound quality, the 8K video supports up to the 22.2CH multi-channel audio system created by Japan's NHK, with a three-layer speaker configuration of 9 channels in the upper layer, 10 channels in the middle layer, and 3 channels in the lower layer, as well as dual-channel low-frequency audio speakers.

The 22.2CH multi-channel audio system can be connected to 24 independent speaker units through cables, which may make the cost very high, and the installation is very complicated for general household use. In addition, the 22.2CH multi-channel sound system broadcasts sound waves through traditional speakers in a 360-degree radiation manner, which has a great sense of space and presents the audience a concert hall like experience. However, it may cause noise interference for audience who prefer not to hear the sound waves.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a flowchart of an embodiment of a directional sound transmission method of the present disclosure;

FIG. 2 is a schematic diagram of an embodiment of an application environment for the directional sound transmission method of the present disclosure;

FIG. 3 is a schematic diagram of an embodiment of an application environment for calculating three-dimensional (3D) coordinate information of a person of the present disclosure;

FIG. 4 is a schematic diagram of a first embodiment of a calculation process for the 3D coordinate information of the person of the present disclosure;

FIG. 5 is a schematic diagram of a second embodiment of a calculation process for the 3D coordinate information of the person of the present disclosure;

FIG. 6 is a schematic diagram of a first embodiment of an application environment for selecting an ultrasonic transducer transmitter suitable for characters of the current person of the present disclosure;

FIG. 7 is a schematic diagram of the growth and development curve of interpupillary distances;

FIG. 8 is a schematic diagram of a second embodiment of an application environment for selecting an ultrasonic transducer transmitter suitable for characters of the current person of the present disclosure;

FIG. 9 is a schematic diagram of a first embodiment of an application environment for dynamic selection of the optimal ultrasonic transducer transmitter of the present disclosure;

FIG. 10 is a schematic diagram of a second embodiment of an application environment for dynamic selection of the optimal ultrasonic transducer transmitter of the present disclosure;

FIG. 11 is a block diagram of an embodiment of the hardware architecture of an electronic device using the method of the present disclosure; and

FIG. 12 is a schematic diagram of an embodiment of functional blocks of the electronic device using the method of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

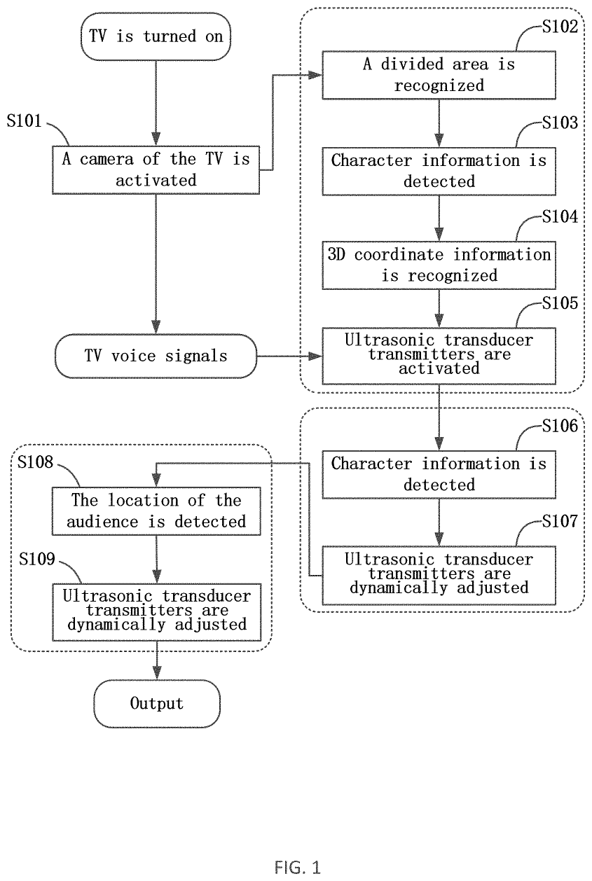

FIG. 1 is a flowchart of an embodiment of a directional sound transmission method of the present disclosure. According to different needs, the order of the steps in the flowchart can be changed, and some steps can be omitted.

In step S101, when a television is turned on, a camera of the TV is activated.

In step S102, a divided area within a detectable range in the space is recognized via a camera detecting system.

In step S103, a first detection operation is performed on character information of a person. In this step, character information of each of persons in the divided area is recognized via the camera detecting system.

In step S104, three-dimensional (3D) coordinate information of each person's face is recognized through the camera detecting system, and the read data is sent back to a positioning system of the camera.

The corresponding character feature information is obtained by extracting facial feature points. A direction vector of the feature points is calculated using a direction vector calculator. A space vector of the feature points is calculated using a space vector calculator. The space coordinate calculator calculates distances between the facial feature points each other and calculates 3D space coordinates of each of the facial feature points according to the direction vector and the space vector.

In step S105, ultrasonic transducer transmitters corresponding to each of persons are activated through the camera detecting system.

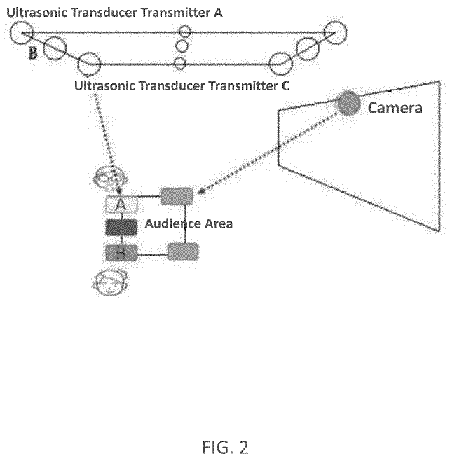

FIG. 2 is a schematic diagram of an embodiment of an application environment for the directional sound transmission method of the present disclosure. For example: there are person A and person B in a room where the camera detecting system is installed. The camera detecting system recognizes faces of person A and person B, and caches 3D coordinates of the faces of person A and person B. After the face recognition is completed, movements of the persons in the divided area are re-detected and collected. For example, if positions of the persons remain unchanged, the corresponding ultrasonic transducer transmitters are driven. On the contrary, if the position of a person moves, new 3D coordinates of the moving person are updated and stored in the positioning system.

Each zone of the divided area is equipped with one or more ultrasonic transducer transmitters, including at least ultrasonic transducer transmitters A and B, and corresponding ultrasonic transducer transmitters are driven according to the coordinate information buffered in the positioning system. In the system, the XY axis coordinates of the ultrasonic transducer transmitters can be calculated according to the positions of the ultrasonic transducer transmitters. Each of the ultrasonic transducer transmitters dynamically adjusts its emission angle according to the 3D coordinates of the persons, so that the sound waves of each of the ultrasonic transducer transmitters are propagated in the direction of the sound wave sources.

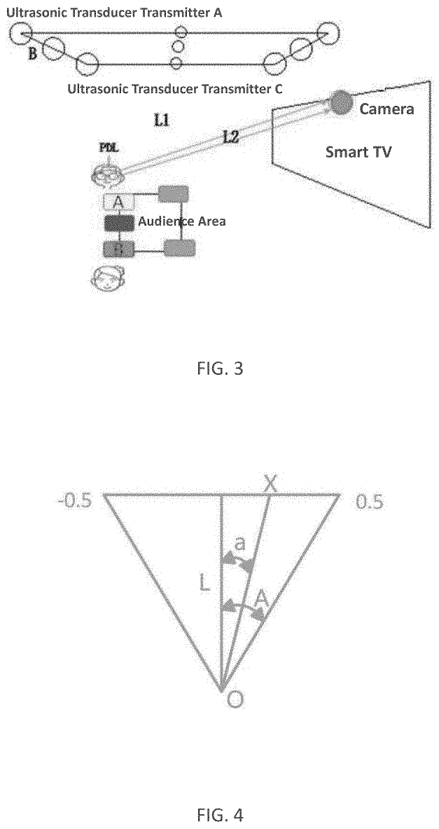

FIG. 3 is a schematic diagram of an embodiment of an application environment for calculating three-dimensional (3D) coordinate information of a person of the present disclosure.

It is assumed that camera C is the spatial origin, distances from point C to the left and right eyes of person A can be configured as position vectors L1 and L2 and their corresponding direction vectors are presented as (L1x, L1y, L1z) and (L2x, L2y, L2z). PDL represents the average pupil interval, and the physical parameters of camera C, VFOV and HFOV and pixel points are represent constants. Referring to FIG. 4, it is assumed that the eye is located at x in a standardized horizontal plane, L is the distance of the Z axis, and the angle of the entire area is 2A (HFOV), the calculation equation is represented as follows:

L×tan aₓ=x (1); and

l×tan(HFOV/2)=0.5 (2).

The formulas aₓ=tan⁻¹(2x×tan(HFOV/2)) and a_{y}=tan⁻¹(2y×tan(VFOV/2)) can be calculated via the equations (1) and (2), representing the angles of x and y in 3D coordinates.

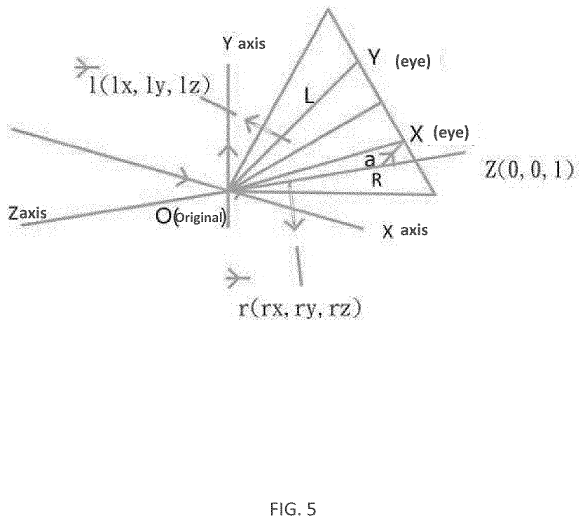

Referring to FIG. 5, the corresponding eye vector direction is represented as V(cosₓ₁,cos a_{y1},{square root over (1−(cos aₓ₁)²−1−(cos a_{y1})²))}, and the left eye and right eye vectors can be obtained using the following equations.

The vector corresponding to X is calculated by:

“Xvector=R*Vvector/cos a=R(lₓ/l_{z},l_{y}/l_{z},l) (3).

The vector corresponding to Y is calculated by:

“Y vector=L*V vector/cos a=L(rₓ/r_{z},r_{y}/r_{z},l) (4)

|X−Y|==the average pupil interval PDL (5).

$$\vert ( X \text{?} - Y \text{?} ) \times {f}_{n} \text{?} = 0 \vert . \qquad ( 6 )$$

$$\vert ( L - {V}_{1} \text{?} \times {f}_{n} / {l}_{z} ) - R \times {V}_{r} \text{?} \times {f}_{n} \text{?} / {r}_{z} = 0 \vert . \qquad ( 7 )$$

$$\text{?} \text{indicates text missing or illegible when filed}$$

The distance of the left eye on the Z axis is calculated by:

$$R = {r}_{z} \times PDL / ( \vert X \text{?} \times Y \text{?} \times {f}_{n} \text{?} / ( X \text{?} \times {f}_{n} \text{?} ) - Y \vert ) . \qquad ( 8 )$$

$$\text{?} \text{indicates text missing or illegible when filed}$$

The distance of the left eye on the Z axis can also be calculated by:

$$R = {r}_{z} \times PDL / ( \vert X \text{?} \times Y \text{?} \times {f}_{n} \text{?} / ( X \text{?} \times {f}_{n} \text{?} ) - Y \vert ) . \qquad ( 9 )$$

$$\text{?} \text{indicates text missing or illegible when filed}$$

Thus, position vectors corresponding to the left and right eyes, [symbol] and [symbol] are calculated as [symbol] =L×/ [symbol] /l_{z} and [symbol] =R× [symbol] /r_{z}.

In the light of the forgoing equations, the 3S coordinates and the direction vectors of the face of the person can be calculated, and a launch angle of the ultrasonic transducer transmitter corresponding to the person can be adjusted according to the information.

In step S106, a second detection operation is performed on the character information of the person and the volume is adjusted to be suitable for the person. This step is mainly to further recognize objects that need to send sound waves, such as old men and children. If the object serves as an old person or a child, the recognized character information is fed back to the main controller to adjust the volume amplitude of the ultrasonic transducer transmitter located in the corresponding area.

In step 107, an angle of the ultrasonic transducer transmitter is dynamically adjusted. If the object does not serve as an old person or a child, it is determined whether the ultrasonic transducer transmitter is configured at an optimal angle. If the ultrasonic transducer transmitter is configured at an optimal angle, the sound signals are sent. If the ultrasonic transducer transmitter is not configured at the optimal angle, an angle of the ultrasonic transducer transmitter is adjusted to send the sound signals.

Each of the ultrasonic transducer transmitter is equipped with a motor controller, a drive system, that controls the direction along the ultrasonic axis. The facial angle information, i.e., control signals, is calculated according to the received facial 3D coordinates. Ultrasonic transducer transmitters located in corresponding areas are driven or activated according to the current facial information stored in the positioning system to guide the sound waves to the positions associated with the listeners. Each ultrasonic transducer transmitter is equipped with a motor to control the left and right direction, while the ultrasonic transducer transmitter can be adjusted for the up and down pitches and the elevation angle.

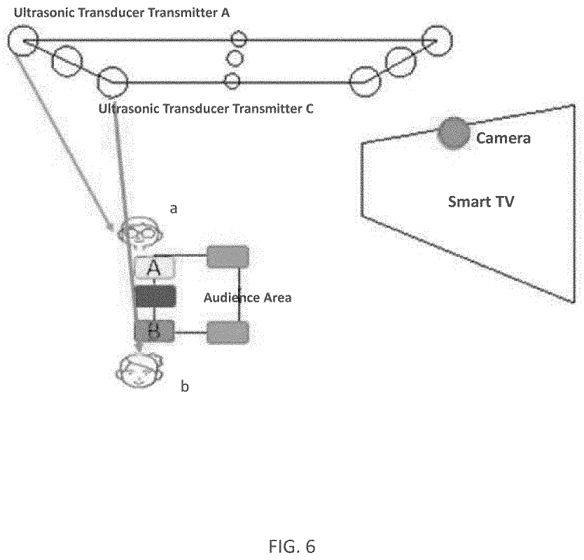

Referring to FIG. 6, one or more corresponding ultrasonic transducers are configured at zone of the divided area. When the camera detecting system detects that there is different character information in multiple areas, corresponding facial 3D images are stored in the system and sent to the positioning system. As person a is located in area A, while person b is located in area B, when the camera detects persons a and b, the corresponding facial 3D coordinates are sent to a main TV system and then ultrasonic transducer transmitters located in corresponding areas are driven.

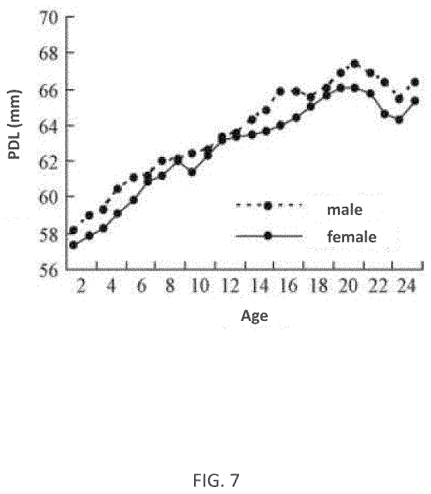

Referring to FIG. 7, average pupil interval refers to different data values at different ages. A range of different average pupil intervals (PDL) between different genders and ages is set. For example, the average pupil intervals (PDL) for girls aged 2 to 11 is 56 to 62 mm, while the average pupil intervals (PDL) for boys aged 2 to 11 is 58 to 62 mm. Furthermore, the family members are generally specific people. Based on the comparison between the saved data and the currently collected values, the corresponding character information can be quickly recognized, so as to feed back to the main TV system to drive the corresponding voice processing systems and driving systems, and then drive the ultrasound transducer transmitters to send the corresponding ultrasound to persons in a specific area.

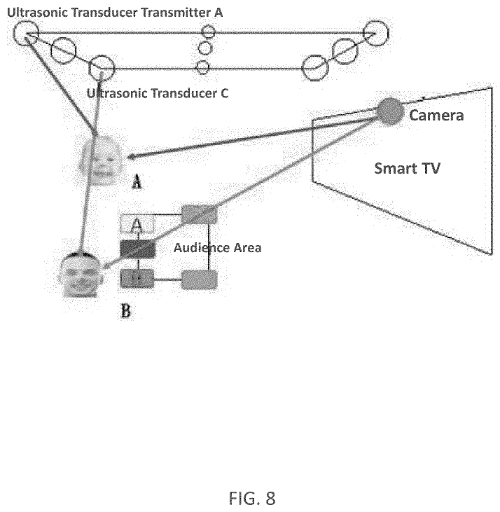

Referring to FIG. 8, in the embodiment of the present invention, the average pupil interval of the eyes is used as an illustration. The devices used to collect character information is not limited to cameras or infrared rays. The recognition data can be facial data, thermal image, voice or other attributes. The embodiment of the present invention uses the average pupil interval (PDL) to drive an ultrasonic transducer transmitter suitable for the current character information.

As it is detected that the person in the corresponding area is an old person or a child, the detected information is fed back to a TV control system. The TV control system sends out the volume amplitude of the ultrasonic transducer transmitter in the area where the person is located, so as to let the old man or children to adapt to the volume without affecting other persons.

In step S108, the location of the audience is detected. This step is to determine whether there are other audiences in the area.

In step S109, if there are other audiences in the area, an angle of the ultrasonic transducer transmitter is dynamically adjusted.

From steps S102 to S105, specific information of a person's face in a certain area and angles of the camera can be obtained. The ultrasonic transducer transmitters can be adjusted and controlled by a pronunciation processing system and the driving system. The pronunciation processing system mainly changes the amplitude of the sound signals sent by the TV and changes corresponding output powers. The driving system mainly changes the launching direction and angle of the ultrasonic transducer transmitter.

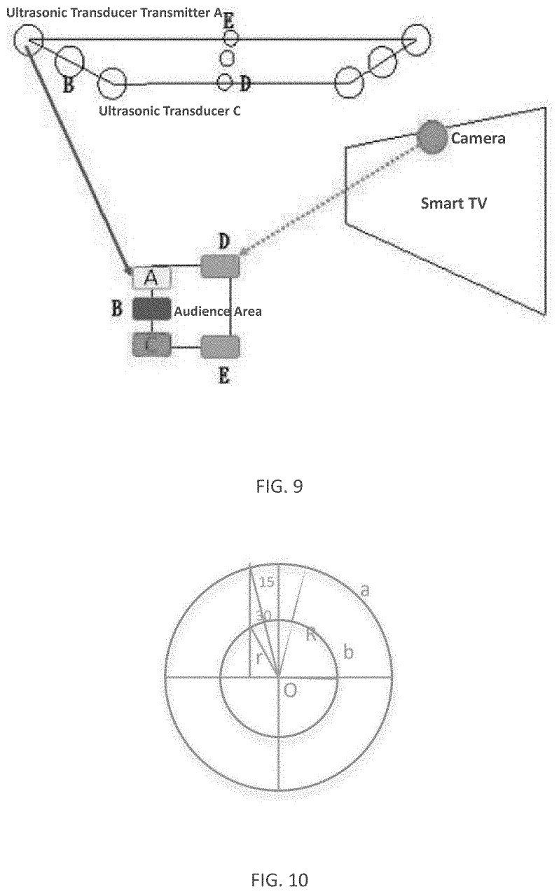

Referring to FIGS. 9 and 10, it is assumed that the best position of the corresponding person A in area A to receive the signal transmitted by the ultrasonic transducer transmitter is R, the position of the ultrasonic transducer transmitter A is 0, and an ultrasonic coverage angle of the corresponding person A is within the range of 30 degrees, as shown in the below circle a, while the corresponding transmitting power is 1 W. When the person A moves beyond the original angle range but is still on circle a, person A can still receive voice signals from the signal source of the ultrasonic transducer transmitter A by adjusting the left and right movements of the driving system. The transmission coverage of ultrasonic transducer transmitter B and other ultrasonic transducer transmitters on the same side is 180 degrees. When the ultrasonic transducer transmitter A moves by a certain displacement, if there are other persons in the range of the adjacent ultrasonic transducer transmitter B, the driving system of the ultrasonic transducer transmitter B also enables the ultrasonic transducer transmitter B to move by the same displacement. On the contrary, if no people is detected, the ultrasonic transducer transmitter B is motionless.

Referring to FIG. 10, when a person moves to the range of the corresponding circle b that raise a different distance, different output powers are adjusted through the voice processing system, and the sound signals are then transferred to the ultrasonic transducer transmission for transmission. At 15 degrees, the transmit power is 1 W, and the corresponding radius is R. When the audience moves to position r, r=0.516R can be obtained according to the trigonometric formula, and the corresponding output power is 1.93 W, i.t., R/0.516R. At this time, the audience located at an area on circle b that covers that range of the angle 15 or 30 of the ultrasonic transducer transmitter can be discovered and the power of the corresponding sound wave processing system can be increased or decreased according to characteristic information of the discovered audience (old man or child and adult), so that the corresponding audience can easily adapt to the volume.

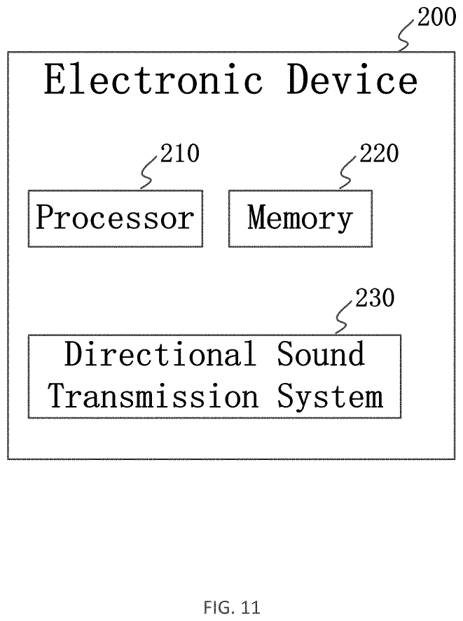

FIG. 11 is a block diagram of an embodiment of the hardware architecture of an electronic device using the directional sound transmission method of the present disclosure. The electronic device 200 may, but is not limited to, connect to a processor 210, a memory 220, and a directional sound transmission system 230 via system buses. The electronic device 200 shown in FIG. 5 may include more or fewer components than those illustrated, or may combine certain components.

The memory 220 stores a computer program, such as the directional sound transmission system 230, which is executable by the processor 210. When the processor 210 executes the directional sound transmission system 230, the blocks in one embodiment of the booting mode configuration method applied in the electronic device 200 are implemented, such as blocks S101 to S109 shown in FIG. 1.

It will be understood by those skilled in the art that FIG. 5 is merely an example of the electronic device 200 and does not constitute a limitation to the electronic device 200. The electronic device 200 may include more or fewer components than those illustrated, or may combine certain components. The electronic device 200 may also include input and output devices, network access devices, buses, and the like.

The processor 210 may be a central processing unit (CPU), or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the directional sound transmission system 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or other volatile solid state storage device.

The directional sound transmission system 230 can be partitioned into one or more modules/units that are stored in the memory 220 and executed by the processor 210. The one or more modules/units may be a series of computer program instructions capable of performing particular functions of the directional sound transmission system 230.

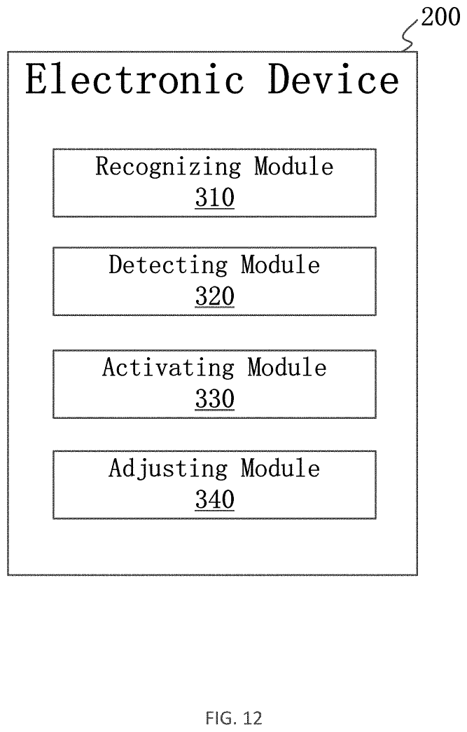

FIG. 12 is a schematic diagram of an embodiment of functional blocks of the electronic device using the method of the present disclosure.

The electronic device 200 comprises a recognizing module 310, a detecting module 320, an activating module 330 and an adjusting module 340.

When a television is turned, a camera of the TV is activated.

The recognizing module 310 recognizes a divided area within a detectable range in the space via a camera detecting system.

The detecting module 320 performs a first detection operation on character information of a person. Character information of each of persons in the divided area is recognized via the camera detecting system.

The recognizing module 310 recognizes three-dimensional (3D) coordinate information of each person's face through the camera detecting system, and the read data is sent back to a positioning system of the camera.

The corresponding character feature information is obtained by extracting facial feature points. A direction vector of the feature points is calculated using a direction vector calculator. A space vector of the feature points is calculated using a space vector calculator. The space coordinate calculator calculates distances between the facial feature points each other and calculates 3D space coordinates of each of the facial feature points according to the direction vector and the space vector.

The activating module 330 ultrasonic transducer transmitters corresponding to each of persons are activated through the camera detecting system.

FIG. 2 is a schematic diagram of an embodiment of an application environment for the directional sound transmission method of the present disclosure. For example: there are person A and person B in a room where the camera detecting system is installed. The recognizing module 310 recognizes faces of person A and person B, and caches 3D coordinates of the faces of person A and person B. After the face recognition is completed, the detecting module 320 re-detects and collects movements of the persons in the divided area. For example, if positions of the persons remain unchanged, the drives the corresponding ultrasonic transducer transmitters. On the contrary, if the position of a person moves, the detecting module 320 updates and stores new 3D coordinates of the moving person in the positioning system.

Each zone of the divided area is equipped with one or more ultrasonic transducer transmitters, including at least ultrasonic transducer transmitters A and B, and the adjusting module 340 drives corresponding ultrasonic transducer transmitters according to the coordinate information buffered in the positioning system. In the system, the XY axis coordinates of the ultrasonic transducer transmitters can be calculated according to the positions of the ultrasonic transducer transmitters. Each of the ultrasonic transducer transmitters dynamically adjusts its emission angle according to the 3D coordinates of the persons, so that the sound waves of each of the ultrasonic transducer transmitters are propagated in the direction of the sound wave sources.

FIG. 3 is a schematic diagram of an embodiment of an application environment for calculating three-dimensional (3D) coordinate information of a person of the present disclosure.

It is assumed that camera C is the spatial origin, distances from point C to the left and right eyes of person A can be configured as position vectors L1 and L2 and their corresponding direction vectors are presented as (L1x, L1y, L1z) and (L2x, L2y, L2z). PDL represents the average pupil interval, and the physical parameters of camera C, VFOV and HFOV and pixel points are represent constants. Referring to FIG. 4, it is assumed that the eye is located at x in a standardized horizontal plane, L is the distance of the Z axis, and the angle of the entire area is 2A (HFOV), the calculation equation is represented as follows:

L×tan aₓ=x (1); and

l×tan(HFOV/2)=0.5 (2).

The formulas aₓ=tan⁻¹(2x×tan(HFOV/2)) and a_{y}=tan⁻¹(2y×tan(VFOV/2)) can be calculated via the equations (1) and (2), representing the angles of x and y in 3D coordinates.

Referring to FIG. 5, the corresponding eye vector direction is represented as V(cos aₓ₁,cos a_{y1}, {square root over (1−(cos aₓ₁)²−1−(cos a_{y1})²))}, and the left eye and right eye vectors can be obtained using the following equations.

The vector corresponding to X is calculated by:

“X vector=R*V vector/cos a=R(lₓ/l_{z},l_{y}/l_{z},l) (3).

The vector corresponding to Y is calculated by:

“Y vector=L*V vector/cos a=L(rₓ/r_{z},r_{y}/r_{z},l) (4).

|X−Y|=the average pupil interval PDL (5).

$$\vert ( X \text{?} - Y \text{?} ) \times {f}_{n} \text{?} = 0 \vert . \qquad ( 6 )$$

$$\vert ( L - {V}_{1} \text{?} \times {f}_{n} / {l}_{z} ) - R \times {V}_{r} \text{?} \times {f}_{n} \text{?} / {r}_{z} = 0 \vert . \qquad ( 7 )$$

$$\text{?} \text{indicates text missing or illegible when filed}$$

The distance of the left eye on the Z axis is calculated by:

$$R = {r}_{z} \times PDL / ( \vert X \text{?} \times Y \text{?} \times {f}_{n} \text{?} / ( X \text{?} \times {f}_{n} \text{?} ) - Y \vert ) . \qquad ( 8 )$$

$$\text{?} \text{indicates text missing or illegible when filed}$$

The distance of the left eye on the Z axis can also be calculated by:

$$R = {r}_{z} \times PDL / ( \vert X \text{?} \times Y \text{?} \times {f}_{n} \text{?} / ( X \text{?} \times {f}_{n} \text{?} ) - Y \vert ) . \qquad ( 9 )$$

$$\text{?} \text{indicates text missing or illegible when filed}$$

Thus, position vectors corresponding to the left and right eyes, [symbol] and [symbol] are calculated as [symbol] =L× [symbol] /l_{z} and [symbol] =R× [symbol] /r_{z}.

In the light of the forgoing equations, the 3S coordinates and the direction vectors of the face of the person can be calculated, and a launch angle of the ultrasonic transducer transmitter corresponding to the person can be adjusted according to the information.

The detecting module 320 performs a second detection operation on the character information of the person and the volume is adjusted to be suitable for the person. This step is mainly to further recognize objects that need to send sound waves, such as old men and children. If the object serves as an old person or a child, the recognized character information is fed back to the main controller to adjust the volume amplitude of the ultrasonic transducer transmitter located in the corresponding area.

The adjusting module 340 an angle of the ultrasonic transducer transmitter is dynamically adjusted. If the object does not serve as an old person or a child, the adjusting module 340 determines whether the ultrasonic transducer transmitter is configured at an optimal angle. If the ultrasonic transducer transmitter is configured at an optimal angle, the sound signals are sent. If the ultrasonic transducer transmitter is not configured at the optimal angle, the adjusting module 340 adjusts an angle of the ultrasonic transducer transmitter to send the sound signals.

Each of the ultrasonic transducer transmitter is equipped with a motor controller, a drive system, that controls the direction along the ultrasonic axis. The facial angle information, i.e., control signals, is calculated according to the received facial 3D coordinates. Ultrasonic transducer transmitters located in corresponding areas are driven or activated according to the current facial information stored in the positioning system to guide the sound waves to the positions associated with the listeners. Each ultrasonic transducer transmitter is equipped with a motor to control the left and right direction, while the ultrasonic transducer transmitter can be adjusted for the up and down pitches and the elevation angle.

Referring to FIG. 6, one or more corresponding ultrasonic transducers are configured at zone of the divided area. When the detecting module 320 detects that there is different character information in multiple areas, corresponding facial 3D images are stored in the system and sent to the adjusting module 340. As person a is located in area A, while person b is located in area B, when the detecting module 320 detects persons a and b, the corresponding facial 3D coordinates are sent to a main TV system and then ultrasonic transducer transmitters located in corresponding areas are driven.

Referring to FIG. 7, average pupil interval refers to different data values at different ages. A range of different average pupil intervals (PDL) between different genders and ages is set. For example, the average pupil intervals (PDL) for girls aged 2 to 11 is 56 to 62 mm, while the average pupil intervals (PDL) for boys aged 2 to 11 is 58 to 62 mm. Furthermore, the family members are generally specific people. Based on the comparison between the saved data and the currently collected values, the corresponding character information can be quickly recognized, so as to feed back to the main TV system to drive the corresponding voice processing systems and driving systems, and then drive the ultrasound transducer transmitters to send the corresponding ultrasound to persons in a specific area.

Referring to FIG. 8, in the embodiment of the present invention, the average pupil interval of the eyes is used as an illustration. The devices used to collect character information is not limited to cameras or infrared rays. The recognition data can be facial data, thermal image, voice or other attributes. The embodiment of the present invention uses the average pupil interval (PDL) to drive an ultrasonic transducer transmitter suitable for the current character information.

As the detecting module 320 detects that the person in the corresponding area is an old person or a child, the detected information is fed back to the activating module 330. The activating module 330 sends out the volume amplitude of the ultrasonic transducer transmitter in the area where the person is located, so as to let the old man or children to adapt to the volume without affecting other persons.

The detecting module 320 detects the location of the audience. This operation is to determine whether there are other audiences in the area.

If there are other audiences in the area, the adjusting module 340 adjusts an angle of the ultrasonic transducer transmitter is dynamically.

Specific information of a person's face in a certain area and angles of the camera can be obtained. The ultrasonic transducer transmitters can be adjusted and controlled by a pronunciation processing system and the driving system. The pronunciation processing system mainly changes the amplitude of the sound signals sent by the TV and changes corresponding output powers. The driving system mainly changes the launching direction and angle of the ultrasonic transducer transmitter.

Referring to FIGS. 9 and 10, it is assumed that the best position of the corresponding person A in area A to receive the signal transmitted by the ultrasonic transducer transmitter is R, the position of the ultrasonic transducer transmitter A is 0, and an ultrasonic coverage angle of the corresponding person A is within the range of 30 degrees, as shown in the below circle a, while the corresponding transmitting power is 1 W. When the person A moves beyond the original angle range but is still on circle a, person A can still receive voice signals from the signal source of the ultrasonic transducer transmitter A by adjusting the left and right movements of the driving system. The transmission coverage of ultrasonic transducer transmitter B and other ultrasonic transducer transmitters on the same side is 180 degrees. When the ultrasonic transducer transmitter A moves by a certain displacement, if there are other persons in the range of the adjacent ultrasonic transducer transmitter B, the driving system of the ultrasonic transducer transmitter B also enables the ultrasonic transducer transmitter B to move by the same displacement. On the contrary, if no people is detected, the ultrasonic transducer transmitter B is motionless.

Referring to FIG. 10, when a person moves to the range of the corresponding circle b that raise a different distance, different output powers are adjusted through the voice processing system, and the sound signals are then transferred to the ultrasonic transducer transmission for transmission. At 15 degrees, the transmit power is 1 W, and the corresponding radius is R. When the audience moves to position r, r=0.516R can be obtained according to the trigonometric formula, and the corresponding output power is 1.93 W, i.t., R/0.516R. At this time, the audience located at an area on circle b that covers that range of the angle 15 or 30 of the ultrasonic transducer transmitter can be discovered and the power of the corresponding sound wave processing system can be increased or decreased according to characteristic information of the discovered audience (old man or child and adult), so that the corresponding audience can easily adapt to the volume.

The advantages of the directional sound transmission method of the embodiment of the present invention are described as follows. The face coordinates of the person in the current space can be identified and the corresponding driving ultrasonic converter is determined, thereby improving the utilization rate and reducing the noise interference. The character information of the persons in the space is identified through the average pupil distance PDL, corresponding ultrasonic transducer transmitters are driven, and corresponding transmission angles and powers are intelligently and dynamically adjusted, which can reduce corresponding power consumption and the humanized composite corresponding people characters. According to the recognized character information, angles and transmission powers of ultrasonic transducer transmitters located in corresponding areas can be intelligently adjusted, instead of a single audio source output.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A directional sound transmission method executable by an electronic device, comprising:
activating a camera of the electronic device;
recognizing a divided area within a detectable range of the camera;
performing a first detection operation on first character information of a first person in the detectable range;
recognizing a first three-dimensional (3D) coordinate information of a face of the first person through the camera, and obtaining the first 3D coordinate information; and
activating a first ultrasonic transducer transmitter corresponding to the first person and sending the sound of the electronic device to the first person.

2. The method of claim 1, further comprising:
performing a second detection operation on the first character information of the first person to adjust volume suitable for the first person; and
dynamically adjusting a first angle of the first ultrasonic transducer transmitter according to the adjusted volume and sending the sound of the electronic device to the first person through the first ultrasonic transducer transmitter.

3. The method of claim 1, wherein the step of performing the second detection operation on the first character information of the first person further comprises:
recognizing whether the first person is a specific person; and
adjusting a volume amplitude of an ultrasonic transducer transmitter in a corresponding area.

4. The method of claim 2, further comprising:
detecting an audience position in the divided area and determining whether there is a second person in the divided area; and
dynamically adjusting a second angle of a second ultrasonic transducer transmitter, if the second person resides in the divided area, and sending the sound of the electronic device to the second person through the second ultrasonic transducer transmitter.

5. The method of claim 2, wherein the step of dynamically adjusting the second angle of the second ultrasonic transducer transmitter further comprises:
if the second person is not a specific person, determining whether the second ultrasonic transducer transmitter is configured at an optimal angle;
if the second ultrasonic transducer transmitter is not configured at the optimal angle, sending the sound of the electronic device to the second person through the second ultrasonic transducer transmitter; and
adjusting the second angle of the second ultrasonic transducer transmitter, if the second ultrasonic transducer transmitter is configured at the optimal angle, and sending the sound of the electronic device to the second person through the second ultrasonic transducer transmitter.

6. The method of claim 1, wherein the step of recognizing the first 3D coordinate information of the face of the first person through the camera further comprises:
obtaining the first character information by extracting first facial feature points of the first person;
calculating a direction vector and a space vector of the first facial feature points; and
calculating the first 3D coordinate information of the first face feature points according to the direction vector and the space vector.

7. The method of claim 6, wherein the step of activating the first ultrasonic transducer transmitter corresponding to the first person further comprises:
re-detecting movements of people in the divided area;
if the people in the divided area do not move, activating corresponding ultrasonic transducer transmitters; and
if at least person in the divided area moves, updating new 3D coordinate information of the moved person.

8. An electronic device, comprising:
a processing module, configured to recognize a divided area within a detectable range in the space;
a performing module, configured to perform a first detection operation on first character information of a first person in the detectable range;
wherein, the processing module recognizes a first three-dimensional (3D) coordinate information of a face of the first person through the camera, and obtains the first 3D coordinate information; and
a controlling module, configured to activate a first ultrasonic transducer transmitter corresponding to the first person and send the sound of the electronic device to the first person.

9. The device of claim 8, further comprising an adjusting module, wherein:
the performing module performs a second detection operation on the first character information of the first person to adjust volume suitable for the first person; and
the adjusting module is configured to dynamically adjust a first angle of the first ultrasonic transducer transmitter according to the adjusted volume and send the sound of the electronic device to the first person through the first ultrasonic transducer transmitter.

10. A non-transitory computer-readable storage medium storing game program which causes a computer to execute:
a process of activating a camera of the electronic device;
a process of recognizing a divided area within a detectable range of the camera;
a process of performing a first detection operation on first character information of a first person in the detectable range;
a process of recognizing a 3D coordinate information of a face of the first person through the camera, and obtaining the first 3D coordinate information; and
a process of activating a first ultrasonic transducer transmitter corresponding to the first person and sending the sound of the electronic device to the first person.
